(19) United States
(12) Patent Application Publication
(10) Pub. No.: US 2012/0330585 A1
(43) Pub. Date: Dec. 27, 2012

(54) Methods and Systems Involving Databases for Energy Usage Data

(75) Inventor: John Christopher Boot, Sandy Springs, GA (US)

(73) Assignee: GENERAL ELECTRIC COMPANY, Schenectady, NY (US)

(21) Appl. No.: 13/168,249

(22) Filed: Jun. 24, 2011

(51) Int. Cl. G06F 19/00

(52) U.S. Cl. 702/61

(57) ABSTRACT

A method includes receiving data associated with time periods that types of electrical devices are used at a metered location and storing the data in a database, associating demographic data with the metered location and storing the associated demographic data in the database, defining a demographic type associated with the metered location, processing the data associated with the time periods that the types of electrical devices are used at the metered location and the demographic data associated with the metered location to define time periods that types of electrical devices are used by demographic types similar to the demographic type associated with the metered location, and identifying an alternative time period that at least one electrical device of the types of electrical devices may be used.

### BACKGROUND OF THE INVENTION

The subject matter disclosed herein relates to energy usage, and particularly to electrical energy usage by energy consumers.

The electrical consumption of a location is typically calculated at monthly intervals, such that a total number of kilowatt hours used over a month is measured with a meter. Improved metering devices allow the electrical consumption of a metered location to be measured and compiled at shorter intervals such as per second intervals or less. The measured data may be used to identify detailed electrical load usage in a metered location.

### BRIEF DESCRIPTION OF THE INVENTION

According to one aspect of the invention, a method includes receiving data associated with time periods that types of electrical devices are used at a metered location and storing the data in a database, associating demographic data with the metered location and storing the associated demographic data in the database, defining a demographic type associated with the metered location, processing the data associated with the time periods that the types of electrical devices are used at the metered location and the demographic data associated with the metered location to define time periods that types of electrical devices are used by demographic types similar to the demographic type associated with the metered location, and identifying an alternative time period that at least one electrical device of the types of electrical devices may be used.

According to another aspect of the invention, a system for analyzing electrical data includes a first database comprising measured load data of a metered location, the measured load data including types of electrical devices and times each type of electrical device is used at the metered location, a second database comprising demographic data associated with the metered location, and a processor operative to receive data from the first database and the second database and generate a third database including the times each type of electrical device is used for a demographic type similar to a demographic type associated with the metered location.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 illustrates an exemplary embodiment of a system 100 that includes a processor.

FIG. 2 illustrates a block diagram that includes a demographic database, a measured load database, and an electrical grid equipment database.

FIG. 3 illustrates exemplary entries of the measured load database of FIG. 2.

FIG. 4 illustrates exemplary entries of the demographic database of FIG. 2.

FIG. 5 illustrates exemplary entries of the electrical grid equipment database of FIG. 2.

FIG. 6 illustrates exemplary entries in the D-L database of FIG. 2.

FIG. 7 illustrates a block diagram of an exemplary method.

The detailed description explains embodiments of the invention, together with advantages and features, by way of example with reference to the drawings.

### DETAILED DESCRIPTION OF THE INVENTION

Electric utilities generate electrical power using a variety of generation arrangements. For example, an electric utility may generate power using a coal powered steam turbine generator that generates power, and a gas turbine generator that may be used to increase the generating capacity during peak loading periods. The utility may also receive purchased power from other grids during peak loading periods. The power generated by the gas turbine or purchased from another system is often more expensive than the power generated by the steam turbine. Utilities operating such grids may offer demand response incentives to electrical consumers to reduce electrical consumption during periods of operation such as during peak loading periods. For some consumer types such as industrial or commercial consumers, utilities may offer incentives to consume power during lower loading periods. For example, a factory that uses electricity may shift the hours of factory operations to avoid consuming electrical power during peak loading times.

Utilities have found that industrial and commercial electrical consumers that may participate in a demand response program are relatively easy to identify due to the small number of industrial consumers as compared to the number of residential consumers. Other consumer types, such as, residential or small business consumers may consume power during peak loading periods that could be consumed at other times. Utilities offer demand response incentive programs to such residential consumers that encourage consumers to consume power during off peak periods or other more desirable consumption periods in a similar manner as the commercial or industrial consumers described above. However, identifying residential consumers who may benefit from such an incentive program is difficult due to the varieties of residential and small business consumers, and the differences in the consumption habits of such consumers. For example, some consumers in a particular area or region may generally not operate electrical devices during peak times. Other consumers in a region may not own certain devices such as, dishwashers or clothes dryers that may consume power during peak times. Further, considering economies of scale, utilities often prefer to identify a geographic area that would include a large number of residential consumers who may utilize an incentive program.

The methods and systems described below allow a utility to collect electrical consumption data for electrical consumers and identify particular times electrical devices are operated. Using demographic data that includes, for example, types of residences (e.g., single family homes or apartments), profiles of electric consumption habits for particular demographic groups or types having particular demographic parameters may be generated. These profiles may be used with demographic data for particular regions to determine whether a particular demand response incentive program is practical and scalable for a region.

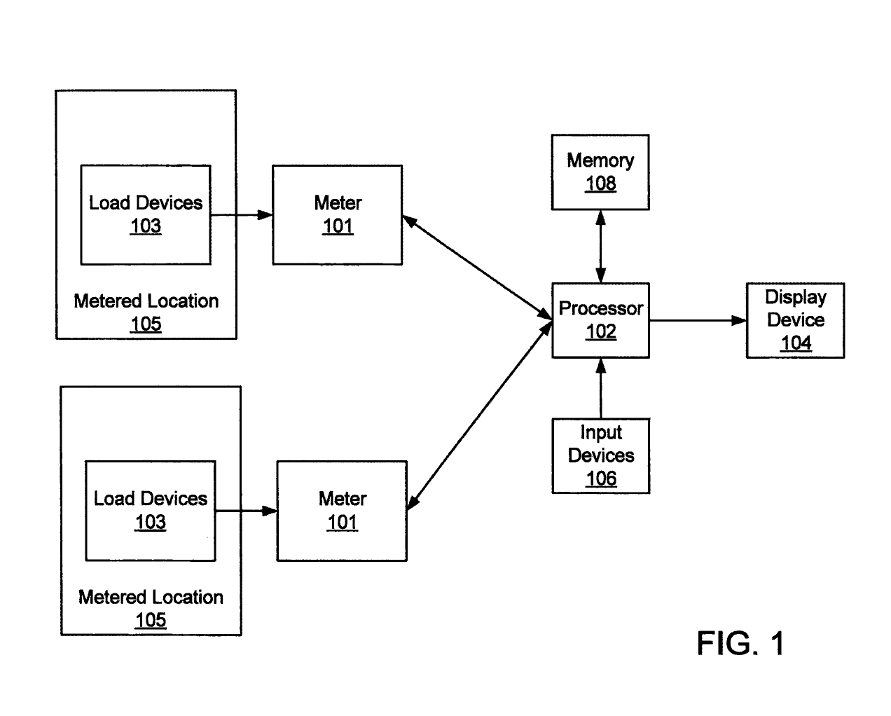

FIG. 1 illustrates an exemplary embodiment of a system 100 that includes a processor 102. The processor 102 is communicatively connected to a display device 104, input devices 106, and a memory or database 108. Meters 101 are communicatively connected to load devices 103 at metered locations 105 and the processor 102. A metered location 105 may include for example, a dwelling or commercial location. The load devices 103 may include any type of device that consumes electrical energy such as, for example, air conditioning units, heating units, ovens, clothes washers and dryers, dishwashers, televisions, toasters, or any other type of similar devices. The meters 101 are operative to measure and record the electrical energy consumed by the load devices 103. The meter 101 includes a processor and memory that allow the meter to measure and record the consumption of electricity by the load devices 103 over short time intervals (e.g., one second or less). The record of electricity usage over the intervals may be used to identify which specific load devices 103 are consuming energy at a particular time by evaluating the recorded data and identifying the load devices 103 based on load consumption characteristics of such devices. For example, the meter 101 may record electricity usage over a day time period at half second intervals. The data recorded by the meter 101 may be analyzed to determine time periods where a specific load device 103 (e.g., a toaster or dish washer) is consuming electricity. The analysis may include for example, comparing current and voltage measurements over a time period with electrical consumption characteristics of load devices 103. The analysis may be performed by the processor 102 as illustrated, or another processor (not shown). Once the specific load devices 103 have been identified, the data may be further processed by the processor 102.

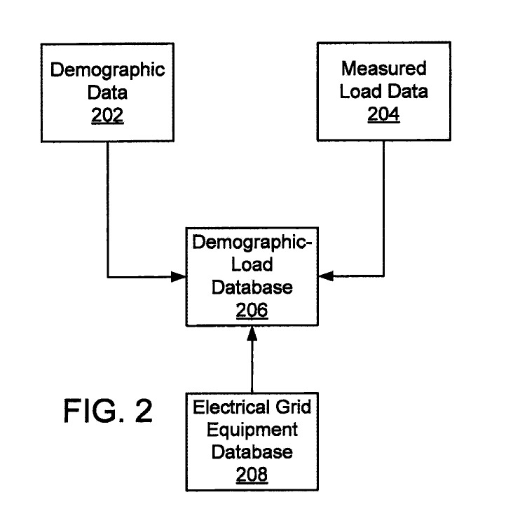

FIG. 2 illustrates a block diagram that includes a demographic database 202, a measured load database 204, and an electrical grid equipment database 208 that may be stored in the memory 108 (of FIG. 1). Given a particular metered location 105, specific load devices 103, and the times that the load devices 103 consume electricity may be identified and associated with the metered location 105 and stored in the measured load database 204 along with demographic data associated with the metered location 105. The demographic database 204 includes demographic data and parameters for electricity consumers in an area. For example, for a particular zip code, the demographic base 202 may include percentages or numbers of types of dwellings (e.g., single family homes, apartments, condominiums); average family incomes; and seasonal weather information. The electrical grid equipment database 208 includes detailed data regarding the location and service areas of specific grid equipment such as, for example, electrical substations.

The demographic database 202, and the measured load database 204 are compiled by the processor 102 into the demographic-load (D-L) database 206 and stored in the memory 108. The D-L database 206 may be used to, for example, identify electricity usage behaviors by users in a financial and/or location demographic that may be changed to reduce consumption of electricity.

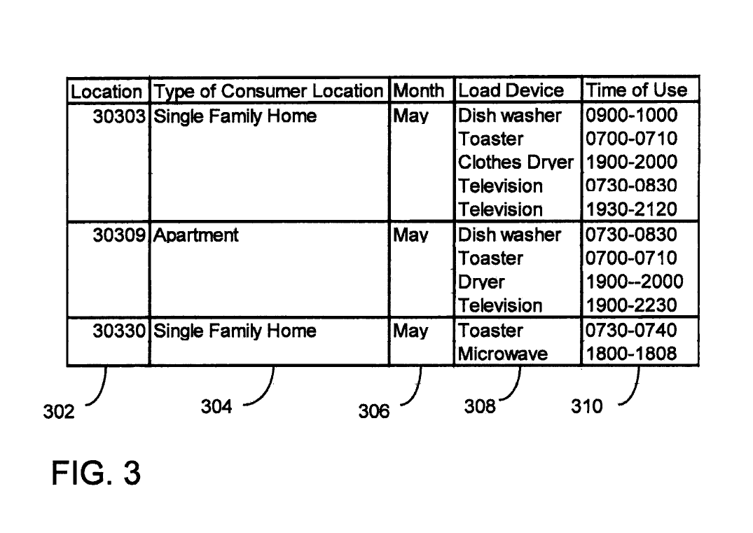

FIG. 3 illustrates exemplary entries of the measured load database 204. The entries include a geographic or grid location field 302, a type of consumer field 304, a month or season field 306, a load device field 308, and a time of use field 310. In the illustrated exemplary embodiment the fields are populated with load device usage and times for three different meter locations. In operation, the measured load database 204 may include entries from hundreds or thousands of consumer locations.

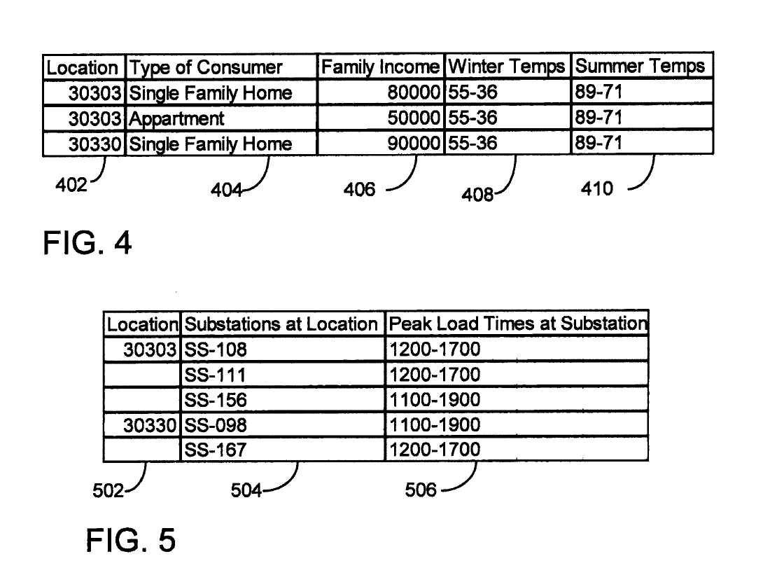

FIG. 4 illustrates exemplary entries of the demographic database 202. The entries include a geographic or grid location field 402, a type of consumer field 404, a family income field 406, a winter temperature field 408, and a summer temperature field 410. The illustrated exemplary entries of the database 202 are merely examples, and may include other similar data or parameters such as, for example, more detailed temperature and seasonal data or number of occupants in a consumer location.

FIG. 5 illustrates exemplary entries of the electrical grid equipment database 208. The entries include a geographic or grid location field 502, a substations at location field 504, and a peak load times at substation field 506.

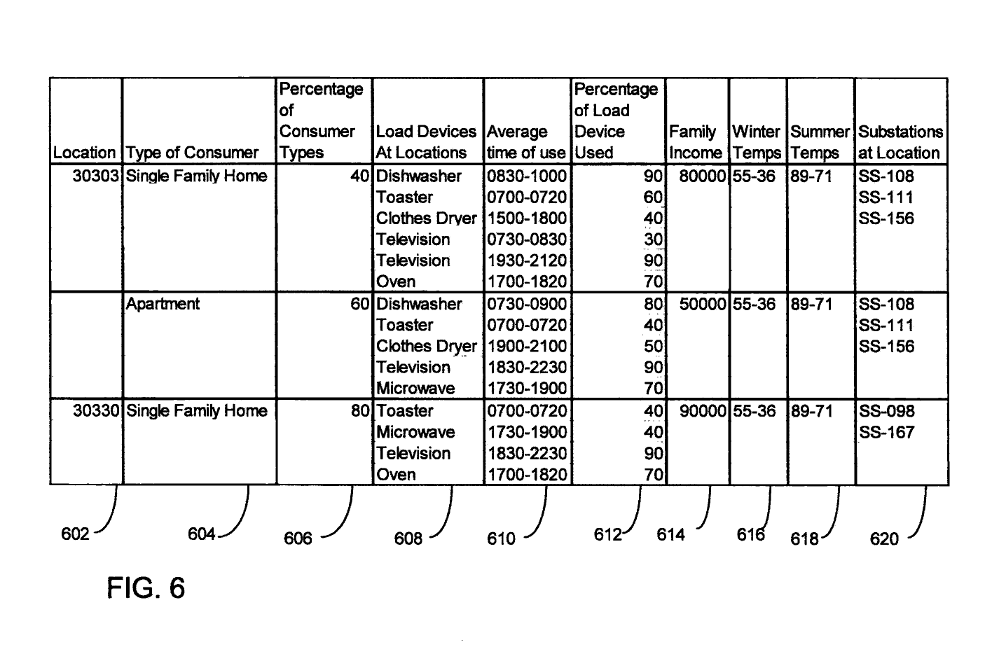

FIG. 6 illustrates exemplary entries in the D-L database 206. The D-L database is populated by processing the demographic database 202, the measured load database 204, and the electrical grid equipment database 208. The D-L database 206 entries include a location field 602, a type of consumer field 604, a percentage of consumer types field 606, a load devices at locations field 608, an average time of use field 610, a percentage of load device used field 612, a family income 614, a winter temperatures field 616, a summer temperatures field 618, and a substations at location field 620.

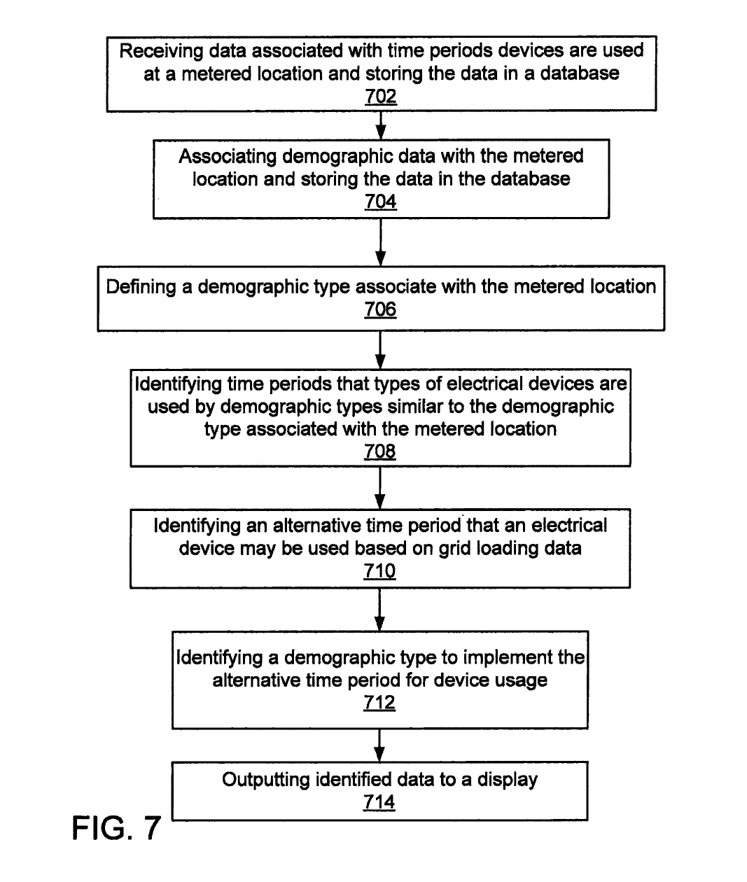

FIG. 7 illustrates a block diagram of an exemplary method for identifying electrical consumers and regions that would benefit from an electrical demand response incentive program. In this regard, the demographic load database 206 (of FIG. 2) may be used to implement the exemplary method. Referring to FIG. 7, in block 702, data associated with time periods devices are used at a metered location is received and stored in a database. In block 704, demographic data is associated with the metered location is stored in the database. In block 706, a demographic type is defined and associated with the metered location. For example, a demographic type may include “single family home; income >$80000; location: 30303.” In block 708, time periods that types of electrical devices are used by similar demographic types similar to the demographic type of the metered location are defined. For example, time periods for particular device usage (e.g., a dishwasher; 0900-1000) are identified for single family homes in location 30303. One or more alternative time periods that the device may be used are identified in block 710. The alternative time periods may be determined using for example, grid loading data and comparing the grid loading data to the time periods for particular device usage. In block 712, a demographic type that may implement the alternative time period for device usage are identified. Once the demographic type is identified, the utility may implement a demand response program for the demographic type by for example, comparing the alternative time period with loading times for grid components that provide power to the location associated with the demographic type. Alternatively, such data may be used to develop electrical devices that may be set to operate during the alternative time period. The resultant data, including the D-L database 206 (of FIG. 2) may be output to a user via the display device 104 (of FIG. 1) in block 714.

The technical effects and benefits of the illustrated embodiments include methods and systems that allow detailed electrical consumption data at metered locations to be used with associated demographic data in a database. The database may be used to identify demographic groups that may benefit from demand response programs or other incentives for modifying electrical consumption.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A method for analyzing electrical usage data comprising:
receiving data associated with time periods that types of electrical devices are used at a metered location and storing the data in a database;
associating demographic data with the metered location and storing the associated demographic data in the database;
defining a demographic type associated with the metered location;
processing the data associated with the time periods that the types of electrical devices are used at the metered location and the demographic data associated with the metered location to define time periods that types of electrical devices are used by demographic types similar to the demographic type associated with the metered location; and
identifying an alternative time period that at least one electrical device of the types of electrical devices may be used.

2. The method of claim 1, wherein the method further includes identifying a demographic type to implement the identified alternative time period for electrical device usage responsive to identifying an alternative time period that the at least one electrical device may be used.

3. The method of claim 1, wherein the method further includes comparing the alternative time period that the device may be used to peak load times at a substation associated with the metered location responsive to identifying the alternative time period that the at least one electrical device may be used.

4. The method of claim 1, wherein the method further includes implementing a demand response program responsive to identifying an alternative time period that the at least one electrical device may be used.

5. The method of claim 4, wherein the demand response program is implemented for demographic types similar to the demographic type associated with the metered location.

6. The method of claim 1, wherein the data associated with time periods that types of electrical devices are used at a metered location is received from the metered location.

7. The method of claim 1, wherein the demographic data associated with the metered location includes a type of dwelling.

8. The method of claim 1, wherein the demographic data associated with the metered location includes a geographic location of the metered location.

9. The method of claim 1, wherein the demographic data associated with the metered location includes an income range associated with the metered location.

10. The method of claim 1, wherein the at least one electrical device includes an electrical appliance.

11. The method of claim 1, wherein the identified alternative time period that the at least one electrical device may be used is output to a user on a display.

12. A system for analyzing electrical usage data comprises:
a first database comprising measured load data of a metered location, the measured load data including types of electrical devices and times each type of electrical device is used at the metered location;
a second database comprising demographic data associated with the metered location; and
a processor operative to receive data from the first database and the second database and generate a third database including the times each type of electrical device is used for a demographic type similar to a demographic type associated with the metered location.

13. The system of claim 12, wherein the system further includes a fourth database comprising electrical grid data associated with the metered location.

14. The system of claim 13, wherein the processor is further operative to generate the third database that further includes the electrical grid data associated with the metered location.

15. The system of claim 12, wherein the processor is further operative to define a demographic type associated with the metered location, identify an alternative time period that an electrical device may be used, and identify a demographic type to implement the identified alternative time period for electrical device usage.

16. The system of claim 12, wherein the demographic data associated with the metered location includes a type of dwelling.

17. The system of claim 12, wherein the demographic data associated with the metered location includes a geographic location of the metered location.

18. The system of claim 12, wherein the demographic data associated with the metered location includes an income associated with the metered location.

19. The system of claim 12, wherein the electrical device includes an electrical appliance.

20. The system of claim 12, wherein the system further includes a display, and the processor is further operative to output the generated third database to a user on the display.
